(19) United States
(12) Patent Application Publication
(10) Pub. No.: US 2020/0219125 A1
(43) Pub. Date: Jul. 9, 2020

(54) System, Method, and Apparatus for Processing a Merchant Redemption Voucher

(71) Applicant: Visa International Service Association, San Francisco, CA (US)

(72) Inventors: Kriti Ranjan Das, Kolkata (IN); Thantya Nishantha Rao, Bangalore (IN); Kapil Kumar Tejra, Rajgarh (IN); Srikanth Yalakkayala, Tirupati (IN); Rabiul Hasan, Chanchal (IN)

(21) Appl. No.: 16/612,943

(22) PCT Filed: May 15, 2017
(86) PCT No.: PCT/US2017/032633

§ 371 Date: Nov. 12, 2019

(51) Int. Cl. G06Q 30/02; G06Q 20/36; G06Q 20/38; G06Q 20/20; G06Q 20/40; G06Q 40/02; G06Q 20/42; G06F 16/23; G06K 7/14

(52) U.S. Cl. CPC G06Q 30/0238; G06Q 20/36; G06Q 20/387; G06Q 20/202; G06Q 20/405; G06Q 20/3674; G06K 7/1413; G06Q 20/204; G06Q 40/02; G06Q 20/208; G06Q 20/42; G06F 16/2379; G06Q 30/0235

(57) ABSTRACT

Provided is a system for processing at least one merchant redemption voucher associated with a customer, including a transaction processing server having a processor programmed or configured to activate at least one merchant redemption voucher for use by the customer at a merchant based at least partially upon an activation request received from the customer, receive, from a merchant point-of-sale system, a transaction request associated with a transaction between the customer and the merchant and comprising a merchant identifier, a transaction amount, and an account identifier, identify the at least one merchant redemption voucher based at least partially on the account identifier, determine if the at least one merchant redemption voucher can be processed based at least partially on the at least one merchant redemption rule, and determine a modified transaction amount based at least partially on the transaction amount and the at least one merchant redemption rule.

### BACKGROUND OF THE INVENTION

### 1. Field of the Invention

This invention relates generally to transaction systems and, in one particular embodiment, to a system, method, and apparatus for processing a merchant redemption voucher through a payment transaction system.

### 2. Technical Considerations

Banks that issue credit cards, debit cards, and other financial instruments implement rewards or points for their consumers that are redeemable at one or more merchants. Currently, such issuer banks allow for their customers to exchange their rewards or points for paper vouchers that are redeemable at a participating merchant of the customer's choosing. In such scenarios, the participating merchants must have a transaction infrastructure in place to handle the redemption-based transactions. Thus, merchants that are unwilling or unable to change their transaction infrastructure are unlikely to participate in such redemption programs due to increased expenses, inconvenience, and technical complexity. This results in less choices for consumers, the potential for fraud through paper-based transactions, and a significant amount of effort for the merchants, issuer banks, transaction service providers, and consumers.

The decentralized nature of redemption-based transactions in existing redemption systems (e.g., using paper-based vouchers at the merchant) may require the merchants to validate the transaction at a later time. This decentralized processing is susceptible to fraud because it relies only on merchants' systems during the transaction and does not necessarily involve all of the interested parties, such as issuer banks and transaction service providers, until after the transaction is completed.

Further, existing redemption systems, although requiring a change in merchants' transaction infrastructures, do not provide merchants with control or flexibility over the vouchers issued to customers. For example, merchants must make arrangements directly with an issuer bank and are unable to define the parameters of the vouchers being offered. This can be especially difficult for small, local merchants that wish to participate in redemption programs because it requires a significant investment in technology while providing little to no customization. Moreover, issuer banks may not be incentivized to engage with such small merchants because the cost and effort for offering vouchers may exceed the amount of business generated.

### SUMMARY OF THE INVENTION

Accordingly, it is an object of the present invention to provide a system, method, and apparatus for processing a merchant redemption voucher that overcomes some or all of the deficiencies of the prior art.

According to a non-limiting embodiment, provided is a system for processing at least one merchant redemption voucher associated with a customer, comprising at least one transaction processing server having at least one processor programmed or configured to: activate at least one merchant redemption voucher for use by the customer at the merchant based at least partially upon an activation request received from the customer, the at least one merchant redemption voucher corresponding to at least one merchant redemption rule; receive, from a merchant point-of-sale system, a transaction request associated with a transaction between the customer and the merchant, the transaction request comprising a merchant identifier, a transaction amount, and an account identifier associated with the customer; in response to receiving the transaction request, identify the at least one merchant redemption voucher based at least partially on the account identifier; determine if the at least one merchant redemption voucher can be processed based at least partially on the at least one merchant redemption rule; in response to determining that the at least one merchant redemption voucher can be processed, determine a modified transaction amount based at least partially on the transaction amount and the at least one merchant redemption rule; and transmit, to the merchant point-of-sale system, an authorization confirmation comprising the modified transaction amount.

According to another non-limiting embodiment, provided is a computer-implemented method for processing at least one merchant redemption voucher associated with a customer, comprising: activating, with at least one processor, at least one merchant redemption voucher for use by the customer at the merchant based at least partially upon an activation request received from the customer, the at least one merchant redemption voucher corresponding to at least one merchant redemption rule; receiving, from a merchant point-of-sale system, a transaction request associated with a transaction between the customer and the merchant, the transaction request comprising a merchant identifier, a transaction amount, and an account identifier associated with the customer; in response to receiving the transaction request, identifying, with at least one processor, the at least one merchant redemption voucher based at least partially on the account identifier; determining, with at least one processor, if the at least one merchant redemption voucher can be processed based at least partially on the at least one merchant redemption rule; in response to determining that the at least one merchant redemption voucher can be processed, determining, with at least one processor, a modified transaction amount based at least partially on the transaction amount and the at least one merchant redemption rule; and transmitting, to the merchant point-of-sale system, an authorization confirmation comprising the modified transaction amount.

According to a further non-limiting embodiment, provided is a computer program product for processing at least one merchant redemption voucher associated with a customer, comprising at least one non-transitory computer-readable medium including program instructions that, when executed by at least one processor, cause the at least one processor to: activate at least one merchant redemption voucher for use by the customer at the merchant based at least partially upon an activation request received from the customer, the at least one merchant redemption voucher corresponding to at least one merchant redemption rule; receive, from a merchant point-of-sale system, a transaction request associated with a transaction between the customer and the merchant, the transaction request comprising a merchant identifier, a transaction amount, and an account identifier associated with the customer; in response to receiving the transaction request, identify the at least one merchant redemption voucher based at least partially on the account identifier; determine if the at least one merchant redemption voucher can be processed based at least partially on the at least one merchant redemption rule; in response to determining that the at least one merchant redemption voucher can be processed, determine a modified transaction amount based at least partially on the transaction amount and the at least one merchant redemption rule; and transmit, to the merchant point-of-sale system, an authorization confirmation comprising the modified transaction amount.

According to another non-limiting embodiment, provided is a system for processing at least one merchant redemption voucher associated with a customer, comprising at least one server computer including at least one processor programmed or configured to: receive a plurality of merchant redemption rules from a merchant, the plurality of merchant redemption rules comprising at least one merchant redemption action; generate, based at least partially on a request from the customer, a merchant redemption voucher based at least partially on the plurality of merchant redemption rules; associate the merchant redemption voucher with an account identifier for the customer; based at least partially upon an activation request received from the customer, activate the at least one merchant redemption voucher; receive, through a merchant point-of-sale system, a transaction request associated with a transaction between the customer and the merchant, the transaction request comprising a merchant identifier, a transaction amount, and the account identifier; in response to receiving the transaction request, perform the at least one merchant redemption action for the transaction; and transmit, to the merchant point-of-sale system, an authorization confirmation comprising a result of the at least one merchant redemption action.

According to a further non-limiting embodiment, provided is a computer-implemented method for processing at least one merchant redemption voucher associated with a customer, comprising: receiving a plurality of merchant redemption rules from a merchant, the plurality of merchant redemption rules comprising at least one merchant redemption action; generating, with at least one processor and based at least partially on a request from the customer, a merchant redemption voucher based at least partially on the plurality of merchant redemption rules; associating the merchant redemption voucher with an account identifier for the customer; based at least partially upon an activation request received from the customer, activating, with at least one processor, the at least one merchant redemption voucher; receiving, through a merchant point-of-sale system, a transaction request associated with a transaction between the customer and the merchant, the transaction request comprising a merchant identifier, a transaction amount, and the account identifier; in response to receiving the transaction request, performing the at least one merchant redemption action for the transaction; and transmitting, to the merchant point-of-sale system, an authorization confirmation comprising a result of the at least one merchant redemption action.

According to a further non-limiting embodiment, provided is a computer program product for processing at least one merchant redemption voucher associated with a customer, comprising at least one non-transitory computer-readable medium including program instructions that, when executed by at least one processor, cause the at least one processor to: receive a plurality of merchant redemption rules from a merchant, the plurality of merchant redemption rules comprising at least one merchant redemption action; generate, based at least partially on a request from the customer, a merchant redemption voucher based at least partially on the plurality of merchant redemption rules; associate the merchant redemption voucher with an account identifier for the customer; based at least partially upon an activation request received from the customer, activate the at least one merchant redemption voucher; receive, through a merchant point-of-sale system, a transaction request associated with a transaction between the customer and the merchant, the transaction request comprising a merchant identifier, a transaction amount, and the account identifier; in response to receiving the transaction request, perform the at least one merchant redemption action for the transaction; and transmit, to the merchant point-of-sale system, an authorization confirmation comprising a result of the at least one merchant redemption action.

Further embodiments or aspects are set forth in the following numbered clauses:

Clause 1: A system for processing at least one merchant redemption voucher associated with a customer, comprising at least one transaction processing server having at least one processor programmed or configured to: activate at least one merchant redemption voucher for use by the customer at the merchant based at least partially upon an activation request received from the customer, the at least one merchant redemption voucher corresponding to at least one merchant redemption rule; receive, from a merchant point-of-sale system, a transaction request associated with a transaction between the customer and the merchant, the transaction request comprising a merchant identifier, a transaction amount, and an account identifier associated with the customer; in response to receiving the transaction request, identify the at least one merchant redemption voucher based at least partially on the account identifier; determine if the at least one merchant redemption voucher can be processed based at least partially on the at least one merchant redemption rule; and in response to determining that the at least one merchant redemption voucher can be processed, determine a modified transaction amount based at least partially on the transaction amount and the at least one merchant redemption rule; and transmit, to the merchant point-of-sale system, an authorization confirmation comprising the modified transaction amount.

Clause 2: The system of clause 2, wherein the at least one processor is further programmed or configured to: receive, from the merchant, the at least one merchant redemption rule; and assign the at least one merchant redemption rule to at least one merchant redemption identifier, wherein the at least one merchant redemption voucher is generated by at least one of the transaction processing server and an issuer bank system based at least partially on a request comprising the merchant redemption identifier.

Clause 3: The system of any of clauses 2 or 3, wherein the activation request is received from the customer through a mobile wallet application executing on a mobile device, and wherein the at least one processor is further programmed or configured to: determine if the merchant redemption voucher is available to the customer; in response to determining that the merchant redemption voucher is available to the customer, activate the at least one merchant redemption voucher for use by the customer at the merchant; and in response to determining that the merchant redemption voucher is unavailable to the customer, transmit, to the mobile wallet application, a notification that the merchant redemption voucher is unavailable.

Clause 4: The system of any of clauses 1-3, wherein the at least one processor is further programmed or configured to: after determining the modified transaction amount, determine whether the merchant redemption voucher is depleted; and update or delete the merchant redemption voucher in at least one database in response to determining that the merchant redemption voucher is depleted.

Clause 5: The system of any of clauses 1-4, wherein the activation request comprises a token corresponding to the account identifier, and wherein the at least one processor is further programmed or configured to: validate the activation request based at least partially on the token; and in response to validating the activation request, activate the at least one merchant redemption voucher for use by the customer at the merchant.

Clause 6: The system of any of clauses 1-5, wherein activating the at least one merchant redemption voucher for use by the customer at the merchant comprises setting an expiration time for the at least one merchant redemption voucher.

Clause 7: The system of any of clauses 1-6, wherein the transaction request is initiated by the customer by at least one of the following: swiping or inserting a physical payment card associated with the account identifier, transmitting an electronic request from a mobile wallet application executing on a mobile device, inputting the account identifier or an associated account identifier into a graphical user interface, or any combination thereof.

Clause 8: The system of any of clauses 1-7, wherein the at least one processor is further programmed or configured to: receive, from an issuer bank system associated with the account identifier, a request to issue the at least one merchant redemption voucher; in response to receiving the request from the issuer bank, validate the at least one merchant redemption voucher; and associate at least one merchant redemption identifier with the account identifier in response to validating the at least one merchant redemption voucher.

Clause 9: The system of clause 8, wherein the at least one merchant redemption identifier is embedded in at least one barcode, and wherein the activation request is initiated by scanning the at least one barcode at the merchant point-of-sale system.

Clause 10: A computer-implemented method for processing at least one merchant redemption voucher associated with a customer, comprising: activating, with at least one processor, at least one merchant redemption voucher for use by the customer at the merchant based at least partially upon an activation request received from the customer, the at least one merchant redemption voucher corresponding to at least one merchant redemption rule; receiving, from a merchant point-of-sale system, a transaction request associated with a transaction between the customer and the merchant, the transaction request comprising a merchant identifier, a transaction amount, and an account identifier associated with the customer; in response to receiving the transaction request, identifying, with at least one processor, the at least one merchant redemption voucher based at least partially on the account identifier; determining, with at least one processor, if the at least one merchant redemption voucher can be processed based at least partially on the at least one merchant redemption rule; in response to determining that the at least one merchant redemption voucher can be processed, determining, with at least one processor, a modified transaction amount based at least partially on the transaction amount and the at least one merchant redemption rule; and transmitting, to the merchant point-of-sale system, an authorization confirmation comprising the modified transaction amount.

Clause 11: The computer-implemented method of clause 10, further comprising: receiving, from the merchant, the at least one merchant redemption rule; and assigning the at least one merchant redemption rule to at least one merchant redemption identifier, wherein the at least one merchant redemption voucher is generated by at least one of the transaction processing server and an issuer bank system based at least partially on a request comprising the merchant redemption identifier.

Clause 12: The computer-implemented method of any of clauses 10 or 11, wherein the activation request is received from the customer through a mobile wallet application executing on a mobile device, further comprising: determining if the merchant redemption voucher is available to the customer; in response to determining that the merchant redemption voucher is available to the customer, activating the at least one merchant redemption voucher for use by the customer at the merchant; and in response to determining that the merchant redemption voucher is unavailable to the customer, transmitting, to the mobile wallet application, a notification that the merchant redemption voucher is unavailable.

Clause 13: The computer-implemented method of any of clauses 10-12, further comprising: after determining the modified transaction amount, determining whether the merchant redemption voucher is depleted; and updating or deleting the merchant redemption voucher in at least one database in response to determining that the merchant redemption voucher is depleted.

Clause 14: The computer-implemented method of any of clauses 10-13, wherein the activation request comprises a token corresponding to the account identifier, further comprising: validating, with at least one processor, the activation request based at least partially on the token; and in response to validating the activation request, activating, with at least one processor, the at least one merchant redemption voucher for use by the customer at the merchant.

Clause 15: The computer-implemented method of any of clauses 10-14, wherein activating the at least one merchant redemption voucher for use by the customer at the merchant comprises setting an expiration time for the at least one merchant redemption voucher.

Clause 16: The computer-implemented method of any of clauses 10-15, wherein the transaction request is initiated by the customer by at least one of the following: swiping or inserting a physical payment card associated with the account identifier, transmitting an electronic request from a mobile wallet application executing on a mobile device, inputting the account identifier or an associated account identifier into a graphical user interface, or any combination thereof.

Clause 17: The computer-implemented method of any of clauses 10-16, further comprising: receiving, from an issuer bank system associated with the account identifier, a request to issue the at least one merchant redemption voucher; in response to receiving the request from the issuer bank, validating the at least one merchant redemption voucher; and associating at least one merchant redemption identifier with the account identifier in response to validating the at least one merchant redemption voucher.

Clause 18: The computer-implemented method of any of clauses 10-17, wherein the at least one merchant redemption identifier is embedded in at least one barcode, and wherein the activation request is initiated by scanning the at least one barcode at the merchant point-of-sale system.

Clause 19: A computer program product for processing at least one merchant redemption voucher associated with a customer, comprising at least one non-transitory computer-readable medium including program instructions that, when executed by at least one processor, cause the at least one processor to: activate at least one merchant redemption voucher for use by the customer at the merchant based at least partially upon an activation request received from the customer, the at least one merchant redemption voucher corresponding to at least one merchant redemption rule; receive, from a merchant point-of-sale system, a transaction request associated with a transaction between the customer and the merchant, the transaction request comprising a merchant identifier, a transaction amount, and an account identifier associated with the customer; in response to receiving the transaction request, identify the at least one merchant redemption voucher based at least partially on the account identifier; determine if the at least one merchant redemption voucher can be processed based at least partially on the at least one merchant redemption rule; in response to determining that the at least one merchant redemption voucher can be processed, determine a modified transaction amount based at least partially on the transaction amount and the at least one merchant redemption rule; and transmit, to the merchant point-of-sale system, an authorization confirmation comprising the modified transaction amount.

Clause 20: A system for processing at least one merchant redemption voucher associated with a customer, comprising at least one server computer including at least one processor programmed or configured to: receive a plurality of merchant redemption rules from a merchant, the plurality of merchant redemption rules comprising at least one merchant redemption action; generate, based at least partially on a request from the customer, a merchant redemption voucher based at least partially on the plurality of merchant redemption rules; associate the merchant redemption voucher with an account identifier for the customer; based at least partially upon an activation request received from the customer, activate the at least one merchant redemption voucher; receive, through a merchant point-of-sale system, a transaction request associated with a transaction between the customer and the merchant, the transaction request comprising a merchant identifier, a transaction amount, and the account identifier; in response to receiving the transaction request, perform the at least one merchant redemption action for the transaction; and transmit, to the merchant point-of-sale system, an authorization confirmation comprising a result of the at least one merchant redemption action.

Clause 21: The system of clause 20, wherein performing the at least one merchant redemption action for the transaction comprises at least one of the following: discounting the transaction amount by a specified amount, discounting the transaction amount by a specified percentage, conferring a complimentary item or service, or any combination thereof.

Clause 22: The system of any of clauses 20 or 21, wherein the result of the at least one merchant redemption action comprises at least one of the following: a reduced transaction amount, a display of a complimentary item or service, or any combination thereof.

Clause 23: A computer-implemented method for processing at least one merchant redemption voucher associated with a customer, comprising: receiving a plurality of merchant redemption rules from a merchant, the plurality of merchant redemption rules comprising at least one merchant redemption action; generating, with at least one processor and based at least partially on a request from the customer, a merchant redemption voucher based at least partially on the plurality of merchant redemption rules; associating the merchant redemption voucher with an account identifier for the customer; based at least partially upon an activation request received from the customer, activating, with at least one processor, the at least one merchant redemption voucher; receiving, through a merchant point-of-sale system, a transaction request associated with a transaction between the customer and the merchant, the transaction request comprising a merchant identifier, a transaction amount, and the account identifier; in response to receiving the transaction request, performing the at least one merchant redemption action for the transaction; and transmitting, to the merchant point-of-sale system, an authorization confirmation comprising a result of the at least one merchant redemption action.

Clause 24: The computer-implemented method of clause 23, wherein performing the at least one merchant redemption action for the transaction comprises at least one of the following: discounting the transaction amount by a specified amount, discounting the transaction amount by a specified percentage, conferring a complimentary item or service, or any combination thereof.

Clause 25: The computer-implemented method of any of clauses 23 or 24, wherein the result of the at least one merchant redemption action comprises at least one of the following: a reduced transaction amount, a display of a complimentary item or service, or any combination thereof.

Clause 26: A computer program product for processing at least one merchant redemption voucher associated with a customer, comprising at least one non-transitory computer-readable medium including program instructions that, when executed by at least one processor, cause the at least one processor to: receive a plurality of merchant redemption rules from a merchant, the plurality of merchant redemption rules comprising at least one merchant redemption action; generate, based at least partially on a request from the customer, a merchant redemption voucher based at least partially on the plurality of merchant redemption rules; associate the merchant redemption voucher with an account identifier for the customer; based at least partially upon an activation request received from the customer, activate the at least one merchant redemption voucher; receive, through a merchant point-of-sale system, a transaction request associated with a transaction between the customer and the merchant, the transaction request comprising a merchant identifier, a transaction amount, and the account identifier; in response to receiving the transaction request, perform the at least one merchant redemption action for the transaction; and transmit, to the merchant point-of-sale system, an authorization confirmation comprising a result of the at least one merchant redemption action.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a schematic diagram for a system for processing merchant redemption vouchers according to the principles of the present invention;

FIG. 2 is a schematic diagram for a system for generating merchant redemption vouchers according to the principles of the present invention;

FIG. 3 is a schematic diagram for a system for requesting merchant redemption vouchers according to the principles of the present invention;

FIG. 4 is a schematic diagram for a system for activating merchant redemption vouchers according to the principles of the present invention;

FIG. 5 is a schematic diagram for a system for redeeming merchant redemption vouchers according to the principles of the present invention; and

FIG. 6 is a process flow diagram for generating and processing at least one merchant redemption voucher according to the principles of the present invention.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

Non-limiting embodiments of the present invention are directed to a system, method, and computer program product for processing at least one merchant redemption action associated with a customer. Embodiments of the invention allow for merchant redemption vouchers associated with merchant redemption actions to be created, requested, and issued such that they can be used by a customer during a payment transaction with a merchant. Rather than requiring merchants to implement a specialized transaction infrastructure for processing redemption-based transactions, non-limiting embodiments of the present invention process and validate redemption-based transactions remote from the merchants and in a way that concurrently processes both the merchant redemption voucher and the underlying payment transaction to provide a seamless transaction for the customers and merchants.

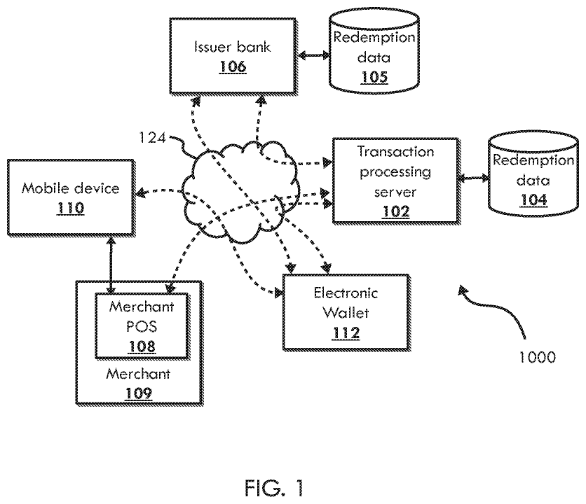

Referring now to FIG. 1, a system 1000 for processing merchant redemption vouchers is shown according to a preferred and non-limiting embodiment. A transaction processing server 102 may include one or more processors and, in some non-limiting embodiments, may be operated by or on behalf of a transaction service provider. The transaction processing server 102 is in communication with a data storage device including a redemption database 104, which may be local or remote to the transaction processing server 102. The transaction processing server 102 is also in communication with one or more issuer banks 106, one or more electronic wallet providers 112, and one or more merchant systems 109 including one or more merchant point-of-sale (POS) systems 108. In some embodiments, the transaction processing server 102 may also be in communication with one or more customer mobile devices 110. The issuer banks 106 may also be in communication with a data storage device including a redemption database 105 and one or more electronic wallet providers 112, and the electronic wallet providers 112 may further be in communication with one or more customer mobile devices 110. In the example shown in FIG. 1, the components of the system 1000 are in communication via a network environment 124, such as the internet, although it will be appreciated that communication may be facilitated over one or more public or private network environments and that various other arrangements are possible.

As used herein, the term “redemption database” may refer to one or more data structures including merchant redemption data for one or more customers, issuer banks, and/or merchants. A redemption database may be a part of a larger transaction database or, in other examples, may be one or more separate databases. Moreover, a redemption database may be stored on one or more data storage devices. The term “merchant redemption data” may refer to any data associated with or relating to a merchant redemption voucher including, for example, merchant redemption rules, merchant redemption identifiers, transaction history, customer data, merchant data, and/or the like.

As used herein, the term “issuer bank” may refer to one or more entities that provide accounts to customers for conducting payment transactions, such as initiating credit and/or debit payments. For example, an issuer bank may provide an account identifier, such as a personal account number (PAN), to a customer that uniquely identifies one or more accounts associated with that customer. The account identifier may be embodied on a physical financial instrument, such as a payment card, and/or may be electronic and used for electronic payments. As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes. An issuer bank may be associated with a bank identification number (BIN) that uniquely identifies it. The terms “issuer bank” and “issuer bank system” may also refer to one or more computer systems operated by or on behalf of an issuer bank, such as a server computer executing one or more software applications. For example, an issuer bank system may include one or more authorization servers for authorizing a payment transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “merchant point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction. A merchant POS system may also include one or more server computers programmed or configured to process online payment transactions through webpages, mobile applications, and/or the like.

As used herein, the term “mobile device” may refer to one or more portable electronic devices that are configured to communicate with one or more networks. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices.

As used herein, the term “electronic wallet” refers to one or more electronic devices and/or software applications that are configured to initiate and/or conduct payment transactions. An electronic wallet may include an application that is executed by a mobile device operated by a customer, and may further include server-side software and databases for maintaining and providing transaction data to the mobile device. An “electronic wallet provider” may include an entity that provides and/or maintains an electronic wallet for a customer, such as Google Wallet™, Android Pay™, Apple Pay®, Samsung Pay®, and/or other like electronic payment systems. In some non-limiting examples, an issuer bank may be an electronic wallet provider.

As used herein, the term “customer rewards” refers to points or other incentives that are provided by an issuer bank or other entity to a customer. Customer rewards may be redeemable with the issuer bank or other entities for a benefit, such as requesting a merchant redemption voucher. The term “merchant redemption voucher,” as used herein, refers to an electronic voucher that may be used at a merchant to initiate a merchant redemption action. A “merchant redemption action” may refer to a benefit that is provided to a customer in exchange for a merchant redemption voucher, such as providing a discount, an offer, a gift, a donation, goods or services, and/or other like benefits. For example, a merchant redemption action may be a credit that is applied to a payment transaction to fully or partially discount the transaction amount associated with a payment transaction. A merchant redemption action may also include a discounted transaction based on a specified or determined percentage, the conveyance of a complimentary item or service, and/or the like. The term “merchant redemption identifier,” as used herein, refers to an identifier that is associated with one or more merchant redemption rules. For example, a merchant redemption identifier may identify a type of merchant redemption voucher among a plurality of different types of merchant redemption vouchers.

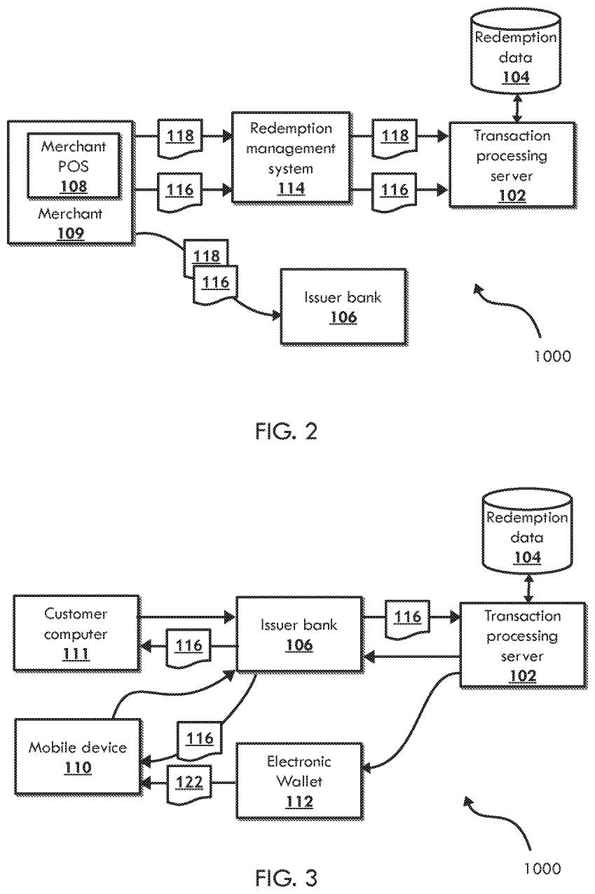

Referring now to FIG. 2, a system 1000 for processing merchant redemption vouchers is shown according to a preferred and non-limiting embodiment. FIG. 2 illustrates non-limiting aspects of the system 1000 for generating merchant redemption vouchers. A merchant 109 may log in to a merchant redemption management system 114 through, for example, a web-based application including one or more graphical user interfaces (GUIs). The GUIs may include one or more selectable options, such as buttons, radio buttons, checkboxes, input boxes, drop-down menus, and/or the like, for creating merchant redemption rules 118. Using the GUIs and selectable options, the merchant 109 may create and/or modify merchant redemption rules 118. In some embodiments, one or more rules files may be uploaded by the merchant 109 through the merchant redemption management system 114 or, in other examples, the merchant redemption management system 114 may generate one or more rules files based on data received from the merchant 109 through the GUIs. It will be appreciated that various other arrangements are possible.

Still referring to FIG. 2, the merchant redemption management system 114 may utilize one or more application programming interfaces (APIs) for interfacing with the transaction processing server 102. In some embodiments, the merchant redemption management system 114 may be part of the transaction processing server 102, such as one or more software applications executing on the transaction processing server 102, and in other embodiments the merchant redemption management system 114 may be one or more separate computer systems executing one or more software applications. The merchant redemption rules 118, either as inputted by the merchant or after being processed and/or formatted by the redemption management system 114, are received, processed, and stored by the transaction processing server 102 in the redemption database 104. The merchant 109, transaction processing server 102, and/or merchant redemption management system 114 may provide one or more merchant redemption identifiers and/or merchant redemption rules to the issuer bank system 106.

In non-limiting embodiments, merchant redemption rules include one or more parameters that define and/or control one or more merchant redemption actions. For example, a merchant redemption rule may specify a type of merchant redemption action (e.g., discounted transaction of an amount, discounted transaction of a percentage, complimentary item or service, and/or the like), temporal restrictions on the merchant redemption action (e.g., dates and/or times that it can be processed, dates and/or times that it cannot be processed, expiration dates, and/or the like), and/or conditions for processing the merchant redemption action (e.g., a minimum purchase amount, a type of or particular good or service, a redemption location, a specific merchant, a type of currency, and/or other conditions). Merchant redemption rules may be structured in various ways, such as an object, XML, JSON, etc., and may be stored in a redemption database 104 or in any other suitable location. In some embodiments, a merchant redemption rules file may be structured with the merchant redemption rules and stored in the redemption database 104 and, in other embodiments, the merchant redemption rules may include entries in the redemption database 104 with other merchant redemption data. In some embodiments, one or more separate rules databases may be used to store the merchant redemption rules. A rule identifier may be used in some embodiments to identify one or more merchant redemption rules in the database 104. It will be appreciated that the merchant redemption rules may be stored and managed in various other ways.

With continued reference to FIG. 2, the merchant 109, using one or more GUIs including selectable options, may also create one or more merchant redemption identifiers 116 through the merchant redemption management system 114. The merchant redemption system 114 may include one or more APIs for receiving merchant redemption identifiers 116 and interfacing with the transaction processing server 102. Merchant redemption identifiers 116 may include, for example, one or more strings of alphanumeric characters, codes, or any other type of identifier. Merchant redemption identifiers 116 may be generated based on identifiers input by the merchant through the merchant redemption management system 114 or, in other examples, may be automatically generated by the merchant redemption management system 114. For example, merchant redemption identifiers may be generated based on customer data, merchant data, merchant redemption rules, and/or randomly.

Still referring to FIG. 2, the merchant redemption identifiers 116, either as inputted by the merchant or after being generated, processed, and/or formatted by the redemption management system 114, may be received and processed by the transaction processing server 102 and stored in the redemption database 104 or elsewhere. The merchant 109 may then communicate the merchant redemption rules 116 and/or the merchant redemption identifiers 118 to the issuer bank system 106. Alternatively or additionally, the transaction processing server 102 may provide the merchant redemption rules 116 and/or the merchant redemption identifiers 118 to the issuer bank system 106. The merchant 109 may also, using selectable options on one or more graphical user interfaces (GUIs), modify one or more merchant redemption vouchers, merchant redemption rules, and/or merchant redemption identifiers. For example, the merchant 109 may transmit a request to the merchant redemption management system 114 to delete a merchant redemption voucher or update a merchant redemption rule associated with a merchant redemption voucher. The merchant redemption management system 114 may then, through an API, communicate a request to the server 102 which, in response to the request, performs the update or deletion. In some embodiments, a merchant redemption identifier may be associated with metadata such as, for example, a voucher style (e.g., one or more colors, font types, or the like that define how a merchant redemption voucher appears in a mobile wallet application), a voucher name, a voucher history (e.g., how many previous vouchers of that type have been issued), an issuer bank BIN, and/or the like.

Referring now to FIG. 3, a system 1000 for processing merchant redemption vouchers is shown according to a preferred and non-limiting embodiment. FIG. 3 illustrates non-limiting aspects of the system 1000 for requesting a merchant redemption voucher. A customer transmits a voucher request to the issuer bank system 106 to redeem customer rewards using a customer computer 111 or mobile device 110. The voucher request may be transmitted through a website of the issuer bank system 106, as an example, although it will be appreciated that the voucher request may be generated and communicated in any number of ways. In a non-limiting embodiment, the voucher request may include a customer identifier, a merchant identifier, and an amount. In response to receiving the request, the issuer bank system 106 transmits a request to the transaction processing server 102 including at least a portion of the information from the customer's voucher request. In some embodiments, the request communicated from the issuer bank system may further include the issuer bank BIN or another identifier, one or more rule identifiers, and metadata, as examples.

Still referring to FIG. 3, in a non-limiting embodiment, the issuer bank system 106, which has access to merchant redemption identifiers stored in a database, determines one or more merchant redemption identifiers 116 from a plurality of possible merchant redemption identifiers that correspond to the customer's voucher request and transmits the merchant redemption identifier(s) 116 and any other related merchant redemption data to the transaction processing server 102. In other examples, instead of having predefined merchant redemption identifiers that were previously created through the merchant redemption management system 114 (not shown in FIG. 3), the issuer bank system 106 may generate new merchant redemption identifiers and/or redemption rules in response to the customer's voucher request to redeem customer rewards. In such examples, the merchant redemption rules may be created based on information provided by the customer.

With continued reference to FIG. 3, the transaction processing server 102, after receiving a request from the issuer bank system 106, validates the merchant redemption identifier(s) 116 based on the redemption database 104 and associates the merchant redemption identifier 116 with an account identifier for the customer. In some non-limiting examples, associating the merchant redemption identifier with the account identifier may involve attaching the merchant redemption identifier to a PAN or other account identifier for that customer by linking database entries, inserting the merchant redemption identifier into an existing database entry, and/or in any other way. Therefore, when the transaction processing server 102 processes a payment transaction using that account identifier or an associated account identifier (e.g., a token associated with a PAN), it can identify the associated merchant redemption identifier 116 and, based on the merchant redemption identifier 116, identify the associated merchant redemption rules for processing the merchant redemption voucher. The transaction processing server 102 may then communicate a confirmation message to the issuer bank system 106 to indicate that the request was successfully processed. The issuer bank system 106 may then provide merchant redemption data to the customer in response to the customer's voucher request, such as but not limited to the merchant redemption identifier 116 or a related identifier.

Still referring to FIG. 3, the merchant redemption identifier 116 may be provided to the customer in plain text, embedded in a one- or two-dimensional barcode (e.g., a QR code or the like), as a hyperlink, and/or in any other way. The issuer bank system 106 may communicate one or more messages to the customer computer 111 and/or customer mobile device 110 via email, text message (SMS, MMS, instant message, and/or the like), dynamic webpage, mobile push notification, and/or the like. The issuer bank system 106 may also communicate a notification to the customer indicating that adding his or her account (e.g., by inputting or scanning an account identifier) to a mobile wallet application will result in the merchant redemption voucher being placed in that mobile wallet. The transaction processing server 102 may also provide the electronic wallet provider 112 with the merchant redemption identifier 116, an account identifier associated with the merchant redemption identifier 116, and/or other redemption data. In such examples, the electronic wallet provider 112 may communicate a merchant redemption voucher 122 associated with the merchant redemption identifier 116 to a mobile wallet application executing on the customer's mobile device 110. In non-limiting embodiments, the merchant redemption identifier 116 and/or merchant redemption voucher 122 may be transmitted via push notification to the mobile device 110. It will be appreciated that non-limiting embodiments of the system may not utilize an electronic wallet provider 112 or a mobile wallet application and, instead, that the customer may initiate a payment transaction with an account identifier or physical payment card at a merchant POS system.

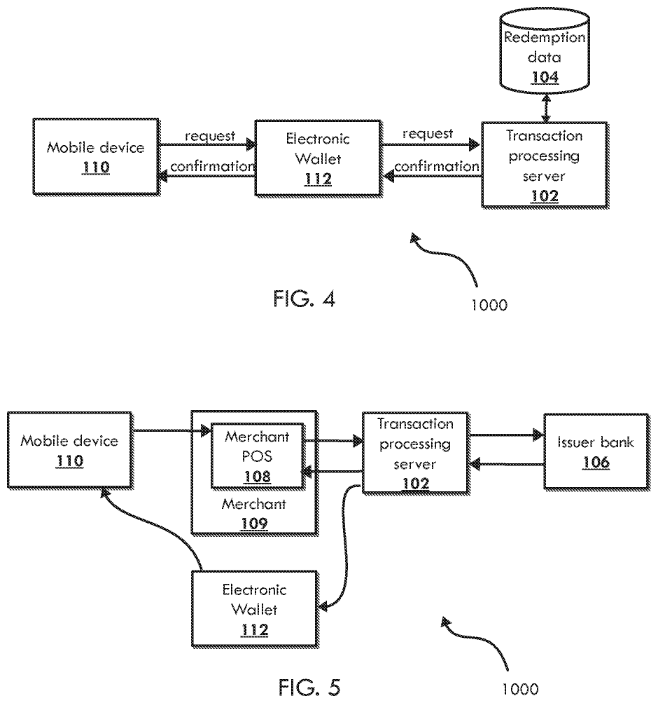

Referring now to FIG. 4, a system 1000 for processing merchant redemption vouchers is shown according to a preferred and non-limiting embodiment. FIG. 4 illustrates non-limiting aspects of the system 1000 for activating a merchant redemption voucher using an electronic wallet provider 112. A customer, through a mobile device 110, communicates an activation request to the electronic wallet provider 112. The activation request may include, for example, a merchant redemption identifier, an identification of a merchant redemption voucher (e.g., a merchant redemption identifier or any other identifier), an activation time (e.g., a date and/or time that the customer wishes to activate the voucher), an activation amount, an identification of one or more customers (e.g., one or more customers that will be authorized to use the voucher), one or more account identifiers (e.g., account identifiers that will be associated with the voucher), and/or the like. The electronic wallet provider 112 may then communicate an activation request to the transaction processing server 102 to activate the merchant redemption voucher. The activation request may be made through an API and, in response to receiving the request, the transaction processing server 102 may automatically determine whether the merchant redemption voucher is available based on the associated merchant redemption identifier and the redemption database 104.

Still referring to FIG. 4, if the merchant redemption voucher has not already been redeemed or is otherwise determined to be available, the transaction processing server 102 may then activate the merchant redemption voucher by recording, in the redemption database 104, an indication that the voucher has been activated (e.g., that the voucher is ready to use). The indication may be, for example, a flag or a predefined value set in a database entry. In some examples, the merchant redemption voucher may be placed in an “active mode” from an “inactive mode.” The transaction processing server 102 may then communicate a confirmation to the electronic wallet provider 112 which, in response to receiving the confirmation, communicates a confirmation to the mobile wallet application on the customer's mobile device 110. In some embodiments in which a customer is provided with a barcode including the merchant redemption identifier, an activation request may be initiated by scanning the barcode at a merchant POS system. In such examples, the barcode may be scanned prior to initiating a payment transaction thereby making the associated merchant redemption action available to the customer during the transaction.

Referring now to FIG. 5, a system 1000 for processing merchant redemption vouchers is shown according to a non-limiting embodiment. FIG. 5 illustrates non-limiting aspects of the system 1000 for redeeming a merchant redemption voucher with a merchant. A customer, after the merchant redemption voucher is activated, initiates a payment transaction with a merchant 109 through a merchant POS system 108. The payment may be initiated with a physical payment card, such as a credit or debit card, or with a mobile device 110 executing a mobile wallet application. Either way, the merchant POS system 108 communicates a transaction request to the transaction processing server 102 which, in response to receiving the transaction request, determines if the account identifier corresponds with a merchant redemption identifier in the merchant redemption database (not shown in FIG. 5). In response to determining that the account identifier corresponds to a merchant redemption identifier, and therefore that the customer has a merchant redemption voucher, the transaction processing server 102 determines if the merchant redemption voucher is activated. In response to determining that the merchant redemption voucher associated with the customer's account identifier is activated, the transaction processing server 102 identifies the associated merchant redemption rules and performs a merchant redemption action associated with the merchant redemption voucher. For example, in some non-limiting embodiments, the merchant redemption action may be a deduction of a voucher amount from the total transaction amount. Other merchant redemption actions may include deducting a percentage of the total transaction amount, providing a complimentary gift, and/or the like.

Still referring to FIG. 5, the new transaction amount is then transmitted to the issuer bank system 106 for approval. In response to approving the new transaction amount, the issuer bank system 106 transmits an approval confirmation message to the transaction processing server 102. In response to receiving the approval confirmation message, the transaction processing server 102 transmits a payment confirmation to the merchant POS system 108 and, in embodiments in which an electronic wallet provider 112 is used, transmits a merchant redemption voucher update notification to the electronic wallet provider 112. The electronic wallet provider 112, in response to receiving the merchant redemption voucher update notification, communicates the notification to a mobile wallet application executing on the customer's mobile device 110 to indicate that the merchant redemption voucher has been used. The transaction processing server 102, issuer bank system 106, and merchant 109 may then settle the transaction. The transaction processing server 102, in response to receiving the transaction request from the merchant POS system 108, may also record an indication in the redemption database 104 that the merchant redemption voucher has been used. For example, the redemption database 104 may indicate that the merchant redemption voucher has been wholly or partially depleted, thereby updating or deleting the corresponding entry from the redemption database 104.

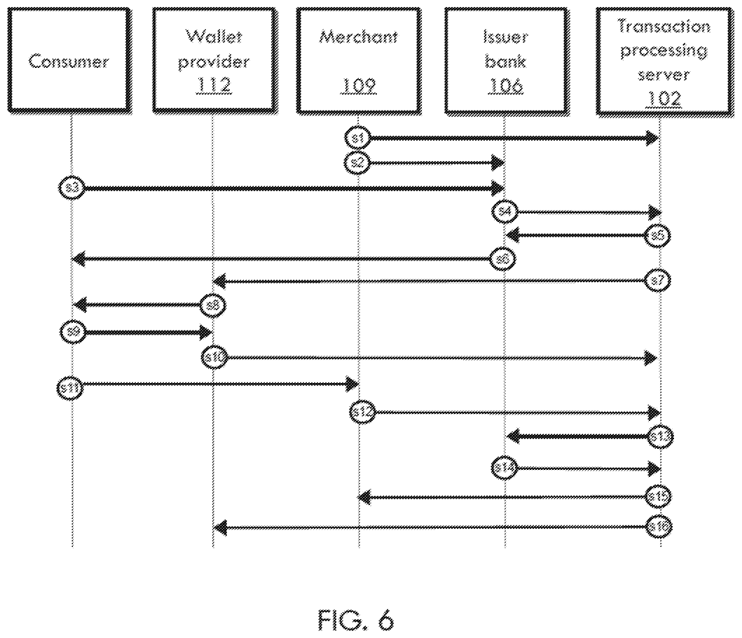

Referring now to FIG. 6, a process flow diagram is shown for processing merchant redemption actions according to a non-limiting embodiment. It will be appreciated that the steps shown in the process flow diagram are for exemplary purposes only and that in various non-limiting embodiments additional or fewer steps may be performed to process a merchant redemption action. In FIG. 6, the “customer” refers to one or more customer mobile devices 110 or customer computers 111 operated by a customer. At a first step (s1), a merchant creates merchant redemption rules and/or merchant redemption identifiers and provides this information to the transaction processing server 102. As explained above, the merchant redemption rules and/or merchant redemption identifiers may be created by the merchant through one or more GUIs, may be generated by a merchant redemption management system (not shown) or the transaction processing server 102, or a combination thereof. At step (s2), the merchant 109 provides the issuer bank system 106 with the merchant redemption rules and/or merchant redemption identifiers through one or more GUIs including selectable options or any other input method. It will be appreciated that the issuer bank system 106 may alternatively or additionally receive the merchant redemption rules and/or merchant redemption identifiers from the transaction processing server 102.

With continued reference to FIG. 6, at a next step (s3), a customer exchanges customer rewards with the issuer bank system 106 for one or more merchant redemption vouchers by communicating a request to the issuer bank system 106 through, for example, one or more GUIs provided by a webpage of the issuer bank system 106, through a mobile application, or the like. The request may include a customer identifier, a merchant, and an amount, as examples. The issuer bank system 106 may then verify the request, determine one or more merchant redemption identifiers, and at step (s4) communicate the merchant redemption identifiers, customer identifier, and/or other information to the transaction processing server 102. The transaction processing server 102 then validates the merchant redemption identifier, associates the merchant redemption identifier with an account identifier for the customer in a database, and communicates a confirmation to the issuer bank system 106 at step (s5). At step (s6), in response to receiving the confirmation, the issuer bank system 106 communicates merchant redemption data, such as a merchant redemption identifier, to the customer.

Still referring to FIG. 6, at step (s7), the transaction processing server 102 identifies one or more account identifiers associated with the customer, such as one or more active tokens associated with the customer's PAN, and communicates this information along with the merchant redemption voucher to the electronic wallet provider 112. The electronic wallet provider 112, at step (s8) and in response to receiving information from the transaction processing server 102, communicates the merchant redemption voucher to a mobile wallet application executing on the customer's mobile device. At this point, the customer is in possession of a merchant redemption voucher associated with one or more merchant redemption actions that has not yet been activated. When the customer wishes to utilize the merchant redemption voucher, the customer, through a mobile wallet application executing on a mobile device, communicates an activation request to the electronic wallet provider 112 at step (s9). It will be appreciated that, in embodiments in which an electronic wallet provider 112 is not utilized, the activation request may be communicated to the issuer bank system 106, the transaction processing server 102, or some other entity. The electronic wallet provider 112, in response to receiving the activation request, communicates an activation request to the transaction processing server 102 at step (s10). The transaction processing server 102 can then validate the activation request by determining if the voucher has already been used and, in response to determining that the voucher has not already been used or is otherwise available, records an indication that the voucher has been activated (e.g., that the voucher is ready to use) in a database.

With continued reference to FIG. 6, the merchant redemption voucher is now activated and ready to be used by the customer. The customer uses the merchant redemption voucher by initiating a payment transaction at the merchant 109 through the merchant POS system at step (s11). The payment transaction may be initiated by using a portable financial device, such as a payment card or mobile wallet application. For example, the payment transaction may be initiated by using payment card for the transaction, such as a debit or credit card, or may be initiated through a mobile wallet application executing on the customer's mobile device 110 (e.g., by initiating an electronic payment with the merchant POS system). From the customer's perspective, once the merchant redemption voucher is activated, the payment transaction is a standard payment transaction that would otherwise be conducted with the merchant 109 in the absence of a merchant redemption voucher. The merchant 109, through the merchant POS system, communicates payment transaction data to the transaction processing server 102 at step (s12) as it would during a standard payment transaction. The payment transaction data may include, for example, a transaction amount and an account identifier associated with the customer.

In response to receiving the payment transaction data, the transaction processing server 102 may determine, based on the account identifier, if there is an active merchant redemption voucher associated with that account identifier and the merchant. If there is, the transaction processing server 102 then performs the merchant redemption action associated with the activated merchant redemption voucher. As an example, the merchant redemption action may involve adjusting (e.g., modifying) the transaction amount to provide a discount based on a voucher amount, adjusting the transaction amount to provide a percentage discount, providing a complimentary item, or the like. At step (s13), the transaction processing server 102 communicates the adjusted transaction amount, or the result of a different merchant redemption action, to the issuer bank system 106 for approval. At step (s14), the issuer bank system 106 communicates an approval confirmation to the transaction processing server 102. In response to receiving the approval confirmation, at step (s15) the transaction processing server 102 communicates an approval confirmation to the merchant POS system associated with the merchant 109. In some embodiments, the approval confirmation and/or other data sent to the merchant POS system may be communicated in one or more fields of an existing ISO financial transaction card originated messages or may be communicated in separate data packets. In examples where the merchant redemption action is a discount resulting in an adjusted transaction amount, the merchant POS system would then conduct the payment transaction based on the adjusted transaction amount. In embodiments in which an electronic wallet provider 112 is used, the transaction processing server 102 may communicate a merchant redemption voucher update to the electronic wallet provider 112 at step (s16) to indicate that the merchant redemption voucher has been used.

It will be appreciated that the system 1000 may be used in connection with any type of payment transaction, including payment transactions at a physical merchant POS system 108 or through an online merchant POS system (e.g., e-commerce platform) of the merchant 109. In embodiments in which a merchant redemption voucher is used in an online transaction through a website or mobile application, the merchant's e-commerce portal may prompt the customer to enter a merchant redemption identifier that was received in a communication from the issuer bank 106. The merchant 109 may then communicate an activation request through an API to the payment transaction server 102 which, in response to receiving the request, verifies the merchant redemption voucher and activates it for use. The customer may then initiate a payment transaction using his or her account identifier, such as a PAN, through the merchant's e-commerce portal.

With reference to FIG. 1, a scenario is explained with respect to a particular merchant 109 and customer utilizing certain non-limiting embodiments of the system 1000. A merchant 109 partners with an issuer bank 106 to offer merchant redemption vouchers by communicating merchant redemption data, such as one or more merchant redemption rules and identifiers, to the issuer bank 106. The issuer bank 106 then provides the merchant redemption data to the payment transaction server 102. A plurality of other merchants may also partner with an issuer bank 106. A customer that has earned customer rewards with the issuer bank 106 based on an amount and/or frequency of past payment transactions seeks to exchange the customer rewards for a merchant redemption voucher from a specific merchant 109. The customer, through a mobile application, webpage, or some other GUI, may choose a predefined merchant redemption voucher and/or request a customer merchant redemption voucher based on inputted data. For example, the customer may select a $100 voucher from the merchant 109. In response to the customer's request, the issuer bank 106 communicates with the payment transaction server 102 which, in some embodiments, communicates with an electronic wallet provider 112. As a result, the customer's account identifier, such as a PAN, is associated with the merchant redemption voucher. The customer may then be provided with the merchant redemption voucher via email, text message, push notification, in a mobile wallet application, and/or the like. The merchant redemption voucher may be a merchant redemption identifier or other data including a merchant redemption identifier, and the customer may activate the merchant redemption voucher for use through a website, mobile application (such as but not limited to a mobile wallet application), clicking a hyperlink, and/or the like. Once the merchant redemption voucher is activated by the customer, the next payment transaction conducted using the associated account identifier at the merchant 109 will result in an automatic performance of the associated merchant redemption action which, in this example, adjusts the transaction amount by subtracting $100. If the transaction amount is less than the voucher amount of $100, the merchant redemption rules may specify whether the merchant redemption voucher can be used partially or whether the transaction amount must be a specified amount, such as over $100. The modified payment transaction is then completed.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A system for processing at least one merchant redemption voucher associated with a customer, comprising at least one transaction processing server having at least one processor programmed or configured to:
activate at least one merchant redemption voucher for use by the customer at a merchant based at least partially upon an activation request received from the customer, the at least one merchant redemption voucher corresponding to at least one merchant redemption rule;
receive, from a merchant point-of-sale system, a transaction request associated with a transaction between the customer and the merchant, the transaction request comprising a merchant identifier, a transaction amount, and an account identifier associated with the customer;
in response to receiving the transaction request, identify the at least one merchant redemption voucher based at least partially on the account identifier;
determine if the at least one merchant redemption voucher can be processed based at least partially on the at least one merchant redemption rule;
in response to determining that the at least one merchant redemption voucher can be processed, determine a modified transaction amount based at least partially on the transaction amount and the at least one merchant redemption rule; and
transmit, to the merchant point-of-sale system, an authorization confirmation comprising the modified transaction amount.

2. The system of claim 1, wherein the at least one processor is further programmed or configured to:
receive, from the merchant, the at least one merchant redemption rule; and
assign the at least one merchant redemption rule to at least one merchant redemption identifier, wherein the at least one merchant redemption voucher is generated by at least one of the transaction processing server and an issuer bank system based at least partially on a request comprising the merchant redemption identifier.

3. The system of claim 1, wherein the activation request is received from the customer through a mobile wallet application executing on a mobile device, and wherein the at least one processor is further programmed or configured to:
determine if the merchant redemption voucher is available to the customer;
in response to determining that the merchant redemption voucher is available to the customer, activate the at least one merchant redemption voucher for use by the customer at the merchant; and
in response to determining that the merchant redemption voucher is unavailable to the customer, transmit, to the mobile wallet application, a notification that the merchant redemption voucher is unavailable.

4. The system of claim 1, wherein the at least one processor is further programmed or configured to:
after determining the modified transaction amount, determine whether the merchant redemption voucher is depleted; and
update or delete the merchant redemption voucher in at least one database in response to determining that the merchant redemption voucher is depleted.

5. The system of claim 1, wherein the activation request comprises a token corresponding to the account identifier, and wherein the at least one processor is further programmed or configured to:
validate the activation request based at least partially on the token; and
in response to validating the activation request, activate the at least one merchant redemption voucher for use by the customer at the merchant.

6. The system of claim 1, wherein activating the at least one merchant redemption voucher for use by the customer at the merchant comprises setting an expiration time for the at least one merchant redemption voucher.

7. The system of claim 1, wherein the transaction request is initiated by the customer by at least one of the following: swiping or inserting a physical payment card associated with the account identifier, transmitting an electronic request from a mobile wallet application executing on a mobile device, inputting the account identifier or an associated account identifier into a graphical user interface, or any combination thereof.

8. The system of claim 1, wherein the at least one processor is further programmed or configured to:
receive, from an issuer bank system associated with the account identifier, a request to issue the at least one merchant redemption voucher;
in response to receiving the request from the issuer bank, validate the at least one merchant redemption voucher; and
associate at least one merchant redemption identifier with the account identifier in response to validating the at least one merchant redemption voucher.

9. The system of claim 8, wherein the at least one merchant redemption identifier is embedded in at least one barcode, and wherein the activation request is initiated by scanning the at least one barcode at the merchant point-of-sale system.

10. A computer-implemented method for processing at least one merchant redemption voucher associated with a customer, comprising:
activating, with at least one processor, at least one merchant redemption voucher for use by the customer at a merchant based at least partially upon an activation request received from the customer, the at least one merchant redemption voucher corresponding to at least one merchant redemption rule;
receiving, from a merchant point-of-sale system, a transaction request associated with a transaction between the customer and the merchant, the transaction request comprising a merchant identifier, a transaction amount, and an account identifier associated with the customer;
in response to receiving the transaction request, identifying, with at least one processor, the at least one merchant redemption voucher based at least partially on the account identifier;
determining, with at least one processor, if the at least one merchant redemption voucher can be processed based at least partially on the at least one merchant redemption rule;
in response to determining that the at least one merchant redemption voucher can be processed, determining, with at least one processor, a modified transaction amount based at least partially on the transaction amount and the at least one merchant redemption rule; and
transmitting, to the merchant point-of-sale system, an authorization confirmation comprising the modified transaction amount.

11. The computer-implemented method of claim 10, further comprising:
receiving, from the merchant, the at least one merchant redemption rule; and
assigning the at least one merchant redemption rule to at least one merchant redemption identifier, wherein the at least one merchant redemption voucher is generated by at least one of a transaction processing server and an issuer bank system based at least partially on a request comprising the merchant redemption identifier.

12. The computer-implemented method of claim 10, wherein the activation request is received from the customer through a mobile wallet application executing on a mobile device, further comprising:
determining if the merchant redemption voucher is available to the customer;
in response to determining that the merchant redemption voucher is available to the customer, activating the at least one merchant redemption voucher for use by the customer at the merchant; and
in response to determining that the merchant redemption voucher is unavailable to the customer, transmitting, to the mobile wallet application, a notification that the merchant redemption voucher is unavailable.

13. The computer-implemented method of claim 10, further comprising:
after determining the modified transaction amount, determining whether the merchant redemption voucher is depleted; and
updating or deleting the merchant redemption voucher in at least one database in response to determining that the merchant redemption voucher is depleted.

14. The computer-implemented method of claim 10, wherein the activation request comprises a token corresponding to the account identifier, further comprising:
validating, with at least one processor, the activation request based at least partially on the token; and
in response to validating the activation request, activating, with at least one processor, the at least one merchant redemption voucher for use by the customer at the merchant.

15. The computer-implemented method of claim 10, wherein activating the at least one merchant redemption voucher for use by the customer at the merchant comprises setting an expiration time for the at least one merchant redemption voucher.

16. The computer-implemented method of claim 10, wherein the transaction request is initiated by the customer by at least one of the following: swiping or inserting a physical payment card associated with the account identifier, transmitting an electronic request from a mobile wallet application executing on a mobile device, inputting the account identifier or an associated account identifier into a graphical user interface, or any combination thereof.

17. The computer-implemented method of claim 10, further comprising:
receiving, from an issuer bank system associated with the account identifier, a request to issue the at least one merchant redemption voucher;
in response to receiving the request from the issuer bank, validating the at least one merchant redemption voucher; and
associating at least one merchant redemption identifier with the account identifier in response to validating the at least one merchant redemption voucher.

18. The computer-implemented method of claim 10, wherein the at least one merchant redemption identifier is embedded in at least one barcode, and wherein the activation request is initiated by scanning the at least one barcode at the merchant point-of-sale system.

19. A computer program product for processing at least one merchant redemption voucher associated with a customer, comprising at least one non-transitory computer-readable medium including program instructions that, when executed by at least one processor, cause the at least one processor to:
activate at least one merchant redemption voucher for use by the customer at a merchant based at least partially upon an activation request received from the customer, the at least one merchant redemption voucher corresponding to at least one merchant redemption rule;
receive, from a merchant point-of-sale system, a transaction request associated with a transaction between the customer and the merchant, the transaction request comprising a merchant identifier, a transaction amount, and an account identifier associated with the customer;
in response to receiving the transaction request, identify the at least one merchant redemption voucher based at least partially on the account identifier;
determine if the at least one merchant redemption voucher can be processed based at least partially on the at least one merchant redemption rule;
in response to determining that the at least one merchant redemption voucher can be processed, determine a modified transaction amount based at least partially on the transaction amount and the at least one merchant redemption rule; and
transmit, to the merchant point-of-sale system, an authorization confirmation comprising the modified transaction amount.

20.-26. (canceled)
